(19) United States
(12) Patent Application Publication
(10) Pub. No.: US 2024/0422693 A1
(43) Pub. Date: Dec. 19, 2024

(54) FULL-DUPLEX NON-ORTHOGONAL MULTIPLE ACCESS-BASED TRANSMIT POWER CONTROL DEVICE EMPLOYING DEEP REINFORCEMENT LEARNING

(71) Applicant: INDUSTRY-UNIVERSITY COOPERATION FOUNDATION HANYANG UNIVERSITY ERICA CAMPUS, Ansan-si (KR)

(72) Inventors: Sung-hyun CHO, Seoul (KR); Se-young AHN, Ansan-si (KR); Soo-hyeong KIM, Ansan-si Gyeonggi-do (KR)

(21) Appl. No.: 18/821,832

(22) Filed: Aug. 30, 2024

Related U.S. Application Data
(63) Continuation of application No. PCT/KR2023/004222, filed on Mar. 30, 2023.

(30) Foreign Application Priority Data
Mar. 31, 2022 (KR) 10-2022-0040438

(51) Int. Cl. H04W 52/16; H04W 52/34

(52) U.S. Cl. CPC H04W 52/16; H04W 52/34

(57) ABSTRACT

Provided is a full-duplex NOMA-based transmit power control device, the device including a state information collector configured to set a role of each of vehicle user equipments (VUEs) constituting a sub-system in a hyper-fractionated zone of a Manhattan mobility model and collect network state information from the sub-system, an actor network configured to determine transmit power of each of the VUEs on the basis of the network state information, a reward calculator configured to calculate a reward value for the network state information and the transmit power, a replay memory configured to store the network state information collected by the network state information collector, the transmit power determined by the actor network, and the reward value calculated by the reward calculator, and a critic network configured to evaluate the transmit power determined by the actor network and give feedback to the actor network.

### CROSS-REFERENCE TO RELATED APPLICATION

This application is a continuation of pending PCT International Application No. PCT/KR2023/004222, which was filed on Mar. 30, 2023, and which claims priority to and the benefit of Korean Patent Application No. 10-2022-0040438, which was filed in the Korean Intellectual Property Office on Mar. 31, 2022, the disclosure of which is incorporated herein by reference in its entirety.

### BACKGROUND

### 1. Field of the Invention

The present invention relates to a full-duplex non-orthogonal multiple access (NOMA)-based transmit power control device employing deep reinforcement learning, and more particularly, to a full-duplex NOMA-based transmit power control device employing deep reinforcement learning for a cellular network-based vehicle communication system.

### 2. Discussion of Related Art

A vehicle-to-everything (V2X) system is a system that transmits or receives information to or from objects affecting a vehicle which wirelessly communicates, as one communication terminal, with a base station or another vehicle. Vehicles may share various kinds of information such as traffic information, danger alerts, and the like, which may be generated therefrom with objects outside the vehicles. V2X communication technologies according to the related art are designed on the basis of dedicated short range communication (DSRC), but lately, active research and development has been conducted on technologies for cellular network-based V2X (cellular V2X (C-V2X)) systems.

Unlike general cellular networks, C-V2X systems carry several problems due to the high mobility of vehicles. The most representative phenomenon is Doppler spread, in which multi-path fading causes the frequency of a signal arriving at a receiver to change widely along the time axis. Therefore, in designing communication technologies for C-V2X systems, it is important to consider a fast-fading characteristic in a shorter coherence time than in cellular systems according to the related art.

Technologies for C-V2X systems according to the related art employ orthogonal multiple access (OMA) in which radio resources are orthogonally allocated and used in a frequency band or time band. However, as autonomous vehicles are becoming more popular and related technologies are being researched and developed more actively, the amount of data produced by vehicles for higher levels of autonomous driving is increasing exponentially, and various forms of infotainment data consumed by autonomous vehicles are also greatly contributing to the formation of vehicle big data. Accordingly, in terms of providing a high-quality communication service to more users, improvement in the performance of existing OMA methods within limited frequency resources is clearly limited.

Accordingly, in Fifth Generation (5G) communication systems, the adoption of a non-orthogonal multiple access (NOMA) technology is considered to accommodate a plurality of users in the same frequency band at the same time.

NOMA methods may be roughly classified into code-domain NOMA and power-domain NOMA. Code-domain NOMA was proposed on the basis of code-domain multiple access (CDMA) and is a technology that employs generalized codewords to decode different data when superimposed signals are generated. Power-domain NOMA was proposed on the basis of power domain multiple access (PDMA) and is a technology that employs successive interference cancellation (SIC) technology for decoding signals which are superimposed because several users transmit the signals with different power levels.

Meanwhile, since the 5G communication system is for the Internet of Things (IoT), the number of users and the types of devices are becoming very diverse. Accordingly, to support a wider variety of devices within limited radio resources, the adoption of full-duplex communication, which supports uplink and downlink at the same time in the same frequency band, is considered in the 5G communication system. Full-duplex communication has the advantage of remarkably increasing a data transmission rate, latency, spectral efficiency, and the like of mobile communication services within limited radio resources. However, there is a disadvantage that self-interference (SI) and co-channel interference (CCI) caused by simultaneously supporting uplink and downlink in the same frequency band may degrade communication quality. SI represents that a downlink transmit signal of one terminal or base station works as a source of interference to the decoding of an uplink receive signal. CCI represents that, when several terminals simultaneously communicate with each other in the same channel, their signals work as sources of interference to each other.

Controlling SI and CCI is a major consideration in the implementation of full-duplex communication technologies. SI and CCI may be mitigated by controlling transmit power of a system. When a base station decodes an uplink signal of a user, a downlink signal works as interference, and thus it is important to control downlink transmit power by considering received strength of the uplink signal. Also, when a system employs NOMA with full-duplex communication, a user serves as a relay node that relays data, and it is important for the user of the relay node to determine appropriate transmit power for decoding received power.

Optimization problems in mobile communication systems generally aim to optimize key performance indicators (KPIs) such as channel capacity, spectral efficiency, latency, and the like. The KPIs may be optimized by several actions, such as assigning radio resources to terminals, adjusting transmit power of a terminal or a base station, and the like, most of which may be expressed as decision-making problems. Reinforcement learning is a representative methodology for solving decision-making problems and may be expressed as a Markov decision process (MDP). An MDP is a mathematical definition of a process of taking an action for transition to a next state in consideration of only a current state and receiving a reward for better actions to gradually improve actions.

Reinforcement learning aims to help an agent go through an MDP in a given environment and establish a policy for determining a next action on the basis of a specific state and a reward that the agent receives upon reaching the specific state. However, when a state space and an action space are very large, the computational complexity of establishing a policy increases exponentially. Deep reinforcement learning is a reinforcement learning algorithm for implementing a policy of reinforcement learning using a deep neural network (DNN) to solve the foregoing computational complexity problem of reinforcement learning.

5G systems that have been actively commercialized lately require more sophisticated decisions in a wireless environment with more complex conditions than existing mobile communication systems. To apply a NOMA technology and a full-duplex communication technology for maximizing the quality of a mobile communication system to vehicle communication systems with more complex conditions, there is a necessity for an algorithm for adopting high decision-making speed and deep reinforcement learning for efficiently processing feedback on a dynamically changing state of the system and very large state and action spaces, to control transmit power of a vehicle and a base station.

### SUMMARY OF THE INVENTION

The present invention is directed to providing a full-duplex non-orthogonal multiple access (NOMA)-based transmit power control device employing deep reinforcement learning for allowing multiple vehicles to communicate with a base station and each other using full-duplex NOMA.

According to an aspect of the present invention, there is provided a full-duplex NOMA-based transmission power control device employing deep reinforcement learning, the transmission power control device including a state information collector configured to set a role of each of vehicle user equipments (VUEs) constituting a sub-system in a hyper-fractionated zone of a Manhattan mobility model and collect network state information from the sub-system, an actor network configured to determine transmit power of each of the VUEs on the basis of the network state information collected by the network state information collector, a reward calculator configured to calculate a reward value for the network state information collected by the network state information collector and the transmit power determined by the actor network, a replay memory configured to store the network state information collected by the network state information collector, the transmit power determined by the actor network, and the reward value calculated by the reward calculator, and a critic network configured to evaluate the transmit power determined by the actor network and give feedback to the actor network.

The sub-system may include VUEs that are present in the hyper-fractionated zone of the Manhattan mobility model and share the same frequency resources in a cellular network-based vehicle communication system.

In the sub-system, the same frequency resources may be shared, first communication links may be established between the VUEs, second communication links may be established between the VUEs and the base station, each of the VUEs may transmit data using the first and second communication links as uplink, and the base station may receive data using the second communication links as downlink.

The network state information collector may set a foremost VUE in a travel direction of vehicles in a fraction among the VUEs as a first VUE, set the VUEs other than the first VUE in the fraction as second VUEs, and set a VUE in another fraction and most adjacent to the first VUE in the travel direction of the vehicles as a third VUE.

The first VUE may transmit a superimposed signal to upward first communication links between the first VUE and the second VUEs and an upward second communication link between the first VUE and the base station using a transmit power difference, and the base station may transmit a superimposed signal to downward second communication links between the base station and the VUEs using the transmit power difference.

The network state information collector may include a channel state information (CSI) calculator configured to collect CSI measurable by a receiving end among the VUEs included in the sub-system, a spectral efficiency (SE) information measurer configured to collect SE information measurable by the receiving end among the VUEs included in the sub-system, a user-base station distance measurer configured to measure a distance between a VUE present at a center of the VUEs included in the sub-system and the base station, and a user-user distance estimator configured to estimate distances between the VUEs included in the sub-system.

The CSI calculator may collect signal-to-interference-plus-noise ratios (SINRs) measured by the receiving end among the VUEs included in the sub-system and measure degrees of signal attenuation related to self-interference (SI) and co-channel interference (CCI) caused by full-duplex communication and CCI caused by NOMA.

The SE information measurer may measure SE measured by the receiving end among the VUEs included in the sub-system and determine whether communication quality of a cellular network-based vehicle communication system has improved.

The user-base station distance measurer may measure distances between the VUEs and the base station and generate information required for deriving transmit power to collect decoding of a superimposed signal and may estimate distances between the VUEs to derive transmit power for minimizing CCI.

The reward calculator may calculate communication quality information on the basis of the network state information and the transmit power and output the communication quality information as a reward.

The actor network may include a policy network configured to determine the transmit power, a target-policy network for stable learning, and an actor optimizer configured to optimize the policy network.

The policy network may determine optimal transmit power using a reward calculated using the network state information and transmit power for a previous state, the target-policy network may separately determine transmit power to prevent an unstable result from being caused by an update of the policy network during a process in which the policy network determines the transmit power, and perform a soft update of mixing parameters of the policy network and parameters of the target-policy network at certain intervals to update the target-policy network, and the actor optimizer may include an algorithm for maximizing a reward to update the policy network.

To prevent biased learning, the replay memory may store transition information including state information and a reward of a previous network and state information of a subsequent network, and provide the transition information in deep reinforcement learning.

The critic network may include a value network configured to analyze the transmit power derived by a policy network, a target-value network for stable learning, and a critic optimizer configured to optimize the policy network.

The value network may evaluate the transmit power on the basis of the transmit power derived by the policy network and the network state information and provide feedback to the policy network, the target-value network may separately evaluate the transmit power to prevent an unstable evaluation from being caused by an update of the value network during a process in which the value network evaluates the transmit power, and perform a soft update of mixing parameters of the value network and parameters of the target-value network at certain intervals to update the target-value network, and the critic optimizer may include an algorithm for maximizing a reward to update the value network.

According to another aspect of the present invention, there is provided a full-duplex NOMA-based transmission power control device employing deep reinforcement learning, the transmission power control device including a sub-system configured to share the same frequency resources in a cellular vehicle-to-everything (C-V2X) system, an initial setting part configured to set roles, such as main vehicle user equipment (VUE), sub-VUE, V2V-VUE, downlink VUE, and the like, to VUEs included in the sub-system, a network state information collector configured to collect network state information from the sub-system, an actor network configured to determine transmit power on the basis of the network state information collected by the network state information collector, a reward calculator configured to calculate a reward for the network state information collected by the network state information collector and the transmit power determined by the actor network, a replay memory configured to store the network state information collected by the network state information collector, the transmit power determined by the actor network, and the reward calculated by the reward calculator, and a critic network configured to evaluate the transmit power determined by the actor network and give feedback to the actor network.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a schematic diagram of a full-duplex non-orthogonal multiple access (NOMA)-based communication system according to an exemplary embodiment of the present invention;

FIG. 2 is a schematic block diagram of a full-duplex NOMA-based transmit power control device employing deep reinforcement learning according to an exemplary embodiment of the present invention;

FIG. 3 is a conceptual diagram of a deep deterministic policy gradient (DDPG) algorithm implemented in a transmit power control device according to an exemplary embodiment of the present invention;

FIG. 4 is a flowchart illustrating a process of training a transmit power control device according to an exemplary embodiment of the present invention;

FIG. 5 is a graph showing a loss value of a policy network versus epoch according to an exemplary embodiment of the present invention;

FIG. 6 is a graph showing a loss value of a value network versus epoch according to an exemplary embodiment of the present invention;

FIG. 7 is a graph showing a reward value of a policy network versus epoch according to an exemplary embodiment of the present invention;

FIG. 8 is a graph showing spectral efficiency (SE) of first to fourth receiving user equipments (UEs) versus epoch according to an exemplary embodiment of the present invention; and

FIG. 9 is a graph showing SE of first and second communication links versus epoch according to an exemplary embodiment of the present invention.

### DETAILED DESCRIPTION OF EXEMPLARY EMBODIMENTS

Specific structural or functional descriptions of embodiments according to the concept of the present invention disclosed in this specification are merely illustrated for the purpose of describing the embodiments according to the concept of the present invention, and the embodiments according to the concept of the present invention may be implemented in various forms and are not limited to the description herein. In the embodiments described herein, the term “module” or “unit” indicates a functional part that performs at least one function or operation and may be implemented as hardware, software, or a combination thereof.

As used herein, the term “unit” or “module” refers to a software component or a hardware component, such as a field-programmable gate array (FPGA) or an application-specific integrated circuit (ASIC), and a “unit” or “module” performs certain functions. However, a “unit” or “module” is not limited to software or hardware. A “unit” or “module” may be configured to be in an addressable storage medium or configured to operate one or more processors. Accordingly, examples of a “unit” or “module” include components, such as software components, object-oriented software components, class components, and task components, processes, functions, attributes, procedures, subroutines, segments of program code, drivers, firmware, microcode, circuits, data, databases, data structures, tables, arrays, and variables. Functions provided in components and “units” or “modules” may be combined into a smaller number of components and “units” or “modules” or subdivided into additional components and “units” or “modules.”

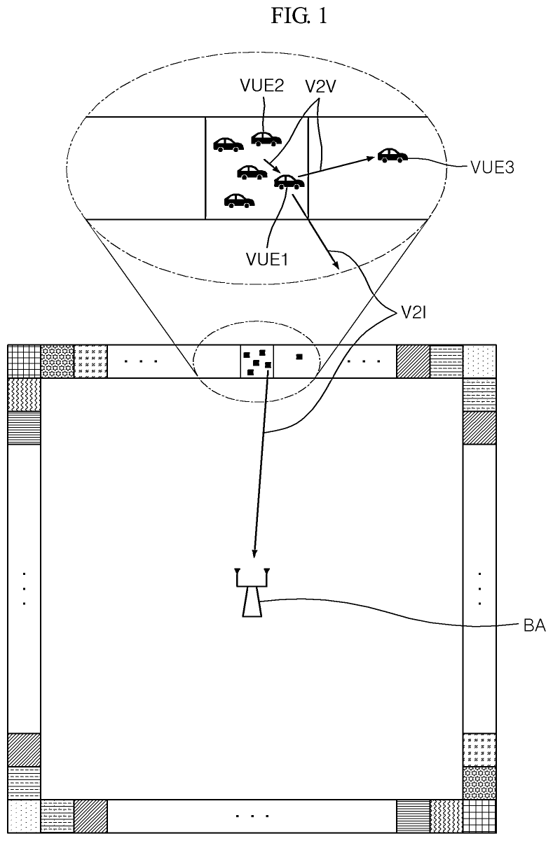

FIG. 1 is a schematic diagram of a full-duplex non-orthogonal multiple access (NOMA)-based communication system according to an exemplary embodiment of the present invention.

Referring to FIG. 1, a Manhattan mobility model is shown to describe cellular network-based vehicle communication between vehicles with a full-duplex NOMA-based transmit power control device employing deep reinforcement learning.

The Manhattan mobility model may include vehicle user equipments (VUEs) and a base station BA, and communication links for communication may be established between the VUEs and the base station BA. The communication links may include first communication links V2V established between the VUEs and second communication links V2I established between the VUEs and the base station BA. Each VUE may transmit data using the first and second communication links V2V and V2I as uplink, and the base station BA may receive data using the second communication links V2I as downlink.

Also, the Manhattan mobility model may hyper-fractionate a road to a certain size to freely acquire radio resources for an uplink, and a certain frequency band may be set for each fraction. VUEs present in each fraction do not use the same frequency band as VUEs present in other fractions and thus may constitute a separate sub-system.

In a sub-system, the foremost VUE in a travel direction of vehicles in a fraction may be a first VUE VUE1, and the VUEs other than the first VUE VUE1 in the fraction may be second VUEs VUE2. The first VUE VUE1 may perform data communication using the first communication links V2V and the second communication link V2I, and the second VUE VUE2 may transmit data to the first VUE VUE1 using the first communication links V2V. Also, the first VUE VUE1 may perform data communication with a third VUE VUE3, which is present in another fraction and most adjacent to the first VUE VUE1 in the travel direction of the vehicles, through a first communication link, and VUEs present in the sub-system may use the same radio resources.

The first VUE VUE1 may transmit superimposed signals to upward first communication links between the first VUE VUE1 and a second VUE VUE2 and an upward second communication link between the first VUE VUE1 and the base station BA using a transmit power difference, and the base station BA may transmit superimposed signals to downward second communication links between the base station BA and the VUEs using a transmit power difference.

The full-duplex NOMA-based transmit power control device employing deep reinforcement learning may have network state information corresponding to a state of a Markov decision process (MDP), transmit power allocation information corresponding to an action, and communication quality information corresponding to a reward.

The network state information may be defined on the basis of information that may be measured in a VUE which receives data. The third VUE VUE3 which receives data from the first VUE VUE1 through an upward first communication link V2V may be set as a first receiving VUE. The base station BA which receives data from the first VUE VUE1 through the upward second communication link V2I may be set as a second receiving VUE. The VUEs VUE1, VUE2, and VUE3 which receive data from the base station BA through the downward second communication links V2I may be set as third receiving VUEs. The first VUE VUE1 which receives data from the second VUEs VUE2 through upward first communication links may be set as a fourth receiving VUE. Channel state information (CSI) and spectral efficiency (SE) information may be collected from the first to fourth receiving VUEs.

CSI CSI_{RX1}, CSI_{RX2}, CSI_{RX3}, and CSI_{RX4} respectively measured in the first to fourth receiving VUEs may be calculated using Expression 1 below.

$${CSI}_{RX 1} = \frac{{P}_{V 2 V} {g}_{0 , N}}{{max}_{i ∈ {𝒢}_{U}} {P}_{sec} {g}_{i , 0} + {σ}_{0}^{2}} \qquad [ Expression 1 ]$$

$${CSI}_{RX 2} = \frac{\text{?} {g}_{0 , BS}}{η {P}_{BS} + {max}_{i ∈ {𝒢}_{U}} {P}_{sec} {g}_{i , BS} + {P}_{V 2 V} {g}_{0 , BS} + {σ}_{0}^{2}}$$

$${CSI}_{RX 3} = \frac{1}{\vert {𝒢}_{D} \vert} {\sum }_{j ∈ {𝒢}_{D}} \frac{{P}_{BS} \text{?}}{( {P}_{V 2 V} + \text{?} ) {g}_{0 , j} + {max}_{i ∈ {𝒢}_{U}} {P}_{sec} {g}_{i , j} + {σ}_{0}^{2}}$$

$${CSI}_{RX 4} = \frac{1}{\vert {𝒢}_{U} \vert} {\sum }_{i ∈ {𝒢}_{U}} \frac{{P}_{sec} {g}_{i , 0}}{η ( {P}_{V 2 V} + \text{?} ) + {σ}_{0}^{2}}$$

$$\text{?} \text{indicates text missing or illegible when filed}$$

Here, [symbol] ={0, 1, 2, . . . , N} may be a set of the VUEs VUE1, VUE2, and VUE3 of one sub-system. In the set [symbol] , 0 may represent the first VUE VUE1, and N may represent the third VUE VUE3. In the set [symbol] , 1 to (N−1) may include a group [symbol] _{U} of the second VUEs VUE2 and a group [symbol] _{D} of the VUEs with the downward second communication links V2I. Accordingly, the union of VUEs with uplink and downlink sharing one frequency resource may be represented as [symbol] _{U}∪ [symbol] _{D}=(1, 2, . . . (N−1).

Also, P_{sec} is transmit power of a second VUE VUE2, P_{V2V} is transmit power of the first VUE VUE1 for the upward first communication link V2V, P_{V2I} is transmit power of the first VUE VUE1 for the upward second communication link V2I, and PBS is transmit power of the base station BA.

g_{a,b} is channel gain between a transmitter a and a receiver b, and a and b are all the elements of the set [symbol] and the base station BA. η is a certain self-interference coefficient for indicating residual interference that may remain after SI removal, and σ₀² is noise of a wireless channel.

CSI may be indicated as a signal-to-interference-plus-noise ratio (SINR) of a received signal. SE information measured by each receiving VUE may be calculated using Expression 2 below.

$$SE = {log}_{2} ( 1 + CSI ) \qquad [ Expression 2 ]$$

Here, the CSI and SE information are CSI and SE information measured by the first to fourth receiving VUEs RX1, RX2, RX3, and RX4.

In the case of applying full-duplex NOMA, the most important factor is controlling SI and CCI. Unlike SI caused by full-duplex communication only, CCI is caused by not only full-duplex communication but also NOMA. Accordingly, CCI may become more problematic in full-duplex NOMA. Therefore, to provide additional information for controlling CCI, four types of distances between a transmitter and a receiver may be measured, estimated, and included in state information.

A distance between a transmitter and a receiver may be calculated using a Euclidean distance as shown in Expression 3 below.

$${d}_{i , j} = \sqrt{{( {x}_{i} - {x}_{j} )}^{2} + {( {y}_{i} - {y}_{j} )}^{2}} \qquad [ Expression 3 ]$$

Here, i and j are all the elements of the set [symbol] of VUEs of the sub-system and the base station BA. xᵢ and yᵢ are x and y coordinates of i, and xⱼ, and yᵢ are x and y coordinates of j. d_{i,j} is a Euclidean distance between i and j.

The network state information may be as shown in Expression 4 below.

$$[ Expression 4 ]$$

$${S}_{t} = [ {CSI}_{R \times 1} , {CSI}_{R \times 2} , {CSI}_{R \times 3} , {CSI}_{R \times 4} , {SE}_{R \times 1} , {SE}_{R \times 2} , {SE}_{R \times 3} , {SE}_{R \times 4} , {d}_{0 , N} , {d}_{0 , BS} , \frac{1}{\vert {𝒢}_{D} \vert} {\sum }_{j ∈ {𝒢}_{D}} {d}_{BS , j} , \frac{1}{\vert {𝒢}_{D} \vert} \frac{1}{\vert {𝒢}_{D} \vert} {\sum }_{i ∈ {𝒢}_{U}} {\sum }_{j ∈ {𝒢}_{U}} {d}_{i , j} ]$$

The transmit power allocation information may include transmit power of the second VUEs VUE2, transmit power of the upward first communication link V2V of the first VUE VUE1, transmit power of the upward second communication link V2I of the first VUE VUE1, and transmit power of the downward second communication link V2I of the base station BA as shown in Expression 5 below.

$${a}_{t} = [ {P}_{sec} , {P}_{V 2 V} , {P}_{V 2 I} , {P}_{BS} ] \qquad [ Expression 5 ]$$

The communication quality information may be designed to induce the VUEs VUE1, VUE2, and VUE3 and the base station BA to achieve a certain level of quality of service (QOS) and also induce receiving VUEs to make enough power difference to decode signals. The communication quality information may be calculated as shown in Expression 6 below.

$${r}_{t} = {\sum }_{i ∈ \{ R \times 1 , R \times 2 , R \times 3 , R \times 4 \}} \frac{{SE}_{i}}{{QoS}_{i}} \times {ACK}_{i} \qquad [ Expression 6 ]$$

Here, QoSᵢ is a QoS level to be ensured for a receiving VUE and may be indicated as SE information. ACKᵢ represents whether a receiving VUE has received a signal normally and may be indicated as a binary value of 0 or 1. When a receiving terminal receives a signal normally, this represents that successive interference cancellation (SIC) of decoding a superimposed signal in NOMA has succeeded.

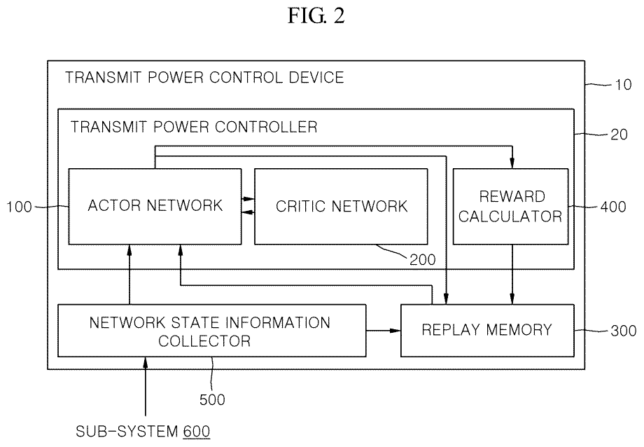

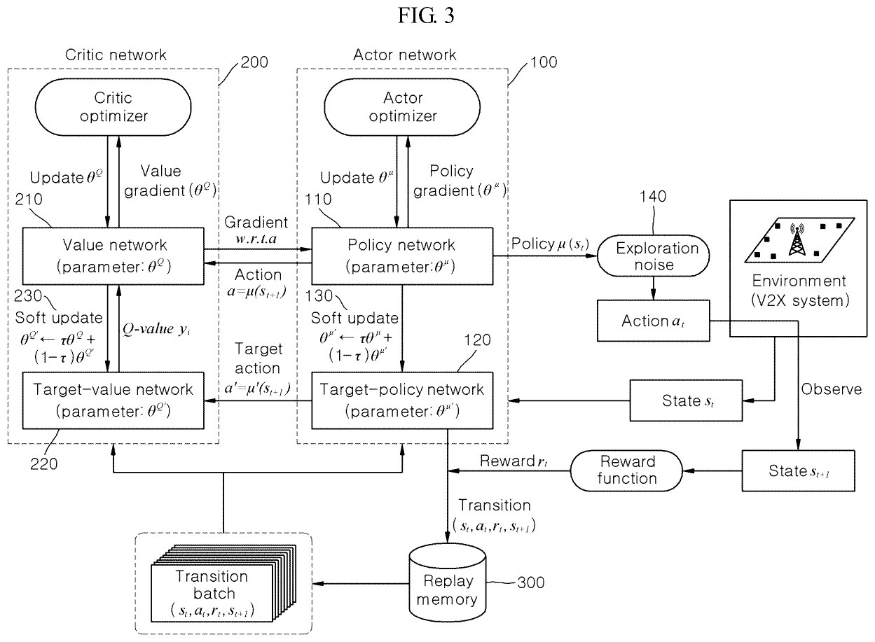

FIG. 2 is a schematic block diagram of a full-duplex NOMA-based transmit power control device employing deep reinforcement learning according to an exemplary embodiment of the present invention, and FIG. 3 is a conceptual diagram of a deep deterministic policy gradient (DDPG) algorithm implemented in a transmit power control device according to an exemplary embodiment of the present invention.

Referring to FIGS. 2 and 3, a full-duplex NOMA-based transmit power control device 10 employing deep reinforcement learning may be designed on the basis of a DDPG algorithm and may include a transmit power controller 20 including an actor network 100, a critic network 200, and a reward calculator 400, a replay memory 300, and a network state information collector 500.

Unlike a general problem of discrete radio resource allocation, applying full-duplex NOMA to a cellular network-based vehicle communication system requires sophisticated transmit power control, and thus it may be difficult to define a discrete action space. The DDPG algorithm is the most stable algorithm among reinforcement learning algorithms for handling a continuous action space and suited for the above problem.

The actor network 100 may include a policy network 110 that determines transmit power of each of the VUEs VUE1, VUE2, and VUE3 on the basis of network state information collected by the network state information collector 500 and determines an action on the basis of a current state and a reward, a target-policy network 120 for stable learning, and an actor optimizer that optimizes the policy network.

The policy network 110 may determine optimal transmit power using a reward that is calculated using the network state information and transmit power for a previous state.

The target-policy network 120 may separately determine transmit power to prevent an unstable result from being caused by a policy network update during a process in which the policy network determines transmit power, and perform a soft update of mixing parameters of the policy network and parameters of the target-policy network at certain intervals to update the target-policy network.

The actor optimizer may include an algorithm for maximizing a reward to update the policy network.

The critic network 200 may evaluate the transmit power determined by the actor network 100 and give feedback to the actor network. The critic network 200 may include a value network 210 that evaluates a value of the action generated by the actor network 100 and the current state, a target-value network 220 for stable learning, and a critic optimizer that optimizes the policy network.

The value network 210 may evaluate the transmit power on the basis of the transmit power derived by the policy network and the network state information and provide feedback to the policy network.

The target-value network 220 may separately evaluate the transmit power to prevent an unstable evaluation from being caused by an update of the value network during a process in which the value network evaluates the transmit power, and perform a soft update of mixing parameters of the value network and parameters of the target-value network at certain intervals to update the target-value network.

The critic optimizer may include an algorithm for maximizing a reward to update the value network.

The replay memory 300 may store the network state information collected by the network state information collector 500, the transmit power determined by the actor network 100, and a reward value calculated by the reward calculator 400. To prevent biased learning, the replay memory 300 may store transition information including state information and a reward of a previous network and state information of a subsequent network and provide the transition information in deep reinforcement learning.

The reward calculator 400 may calculate a reward value for the network state information collected by the network state information collector 500 and the transmit power determined by the actor network, calculate communication quality information on the basis of the network state information and the transmit power, and output the communication quality information as a reward.

The network state information collector 500 may include a CSI calculator that collects CSI which is measurable by a receiving end among the VUEs VUE1, VUE2, and VUE3 included in the sub-system, an SE information measurer that collects SE information which is measurable by the receiving end among the VUEs VUE1, VUE2, and VUE3 included in the sub-system, a user-base station distance measurer that measures a distance between a VUE present at the center of the VUEs included in the sub-system and the base station BA, and a user-user distance estimator that estimates distances between the VUEs included in the sub-system.

The CSI calculator may collect an SINR measured by the receiving end among the VUEs included in the sub-system and measure degrees of signal attenuation related to SI and CCI caused by full-duplex communication and CCI caused by NOMA.

The SE information measurer may measure SE measured by the receiving end among the VUEs included in the sub-system and determine whether communication quality of a cellular network-based vehicle communication system has improved.

The user-base station distance measurer may measure distances between the VUEs and the base station BA and generate information required for deriving transmit power to collect decoding of a superimposed signal. Also, the user-base station distance measurer may estimate distances between the VUEs and derive transmit power for minimizing CCI.

In deep reinforcement learning, calculating an action or a value during an update of the policy network 110 or the value network 210 may be a factor that significantly destabilizes learning.

Therefore, the policy network 110 and the value network 210 may include the target networks 120 and 220 to fix network parameters when calculating an action or value and separately perform a network update. When convergence is not easy and a target network has a very large change, a network update is highly likely to diverge. Accordingly, the DDPG algorithm employs soft updates 130 and 230 to gradually update the network as shown in Expression 7 below.

$${θ}^{{Q}^{′}} ← {τθ}^{Q} + ( 1 - τ ) {θ}^{{Q}^{′}} \qquad [ Expression 7 ]$$

$${θ}^{{μ}^{′}} ← {τθ}^{μ} + ( 1 - τ ) {θ}^{{μ}^{′}}$$

Here, θ^{μ} and θ^{Q} are parameters of the policy network 110 and the value network 210, respectively. θ^{μ′} and θ^{Q′} are parameters of the target-policy network 120 and the target-value network 220, respectively. τ is an update rate coefficient of a target network and has a value within a range [0, 1].

In learning a continuous action space, exploration in which an agent performs a new attempt may be a very important factor. The DDPG algorithm may add certain exploration noise 140 to a determined action, inducing an agent to perform a new attempt.

When reinforcement learning is mainly performed along a certain trajectory, the learning may be biased toward the trajectory. The replay memory 300 may store transition data which may include a previous state, an action, a reward, and a subsequent state and randomly extract and use the stored transition data for learning to reduce the bias of learning and increase variation.

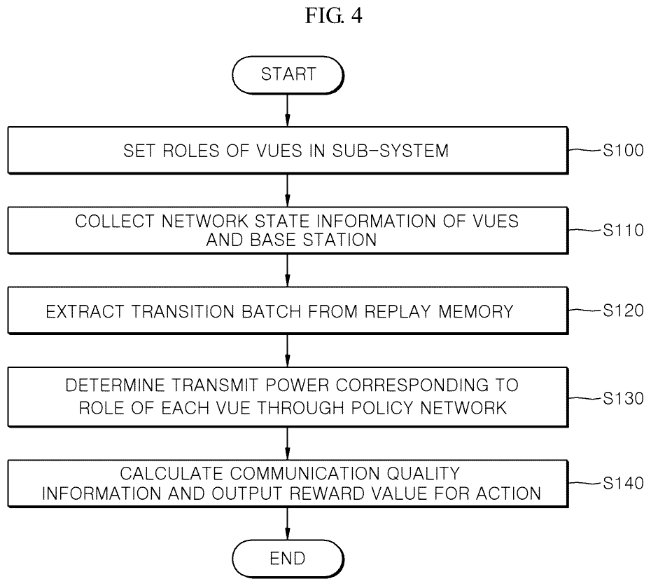

FIG. 4 is a flowchart illustrating a process of training a transmit power control device according to an exemplary embodiment of the present invention.

Referring to FIG. 4, a process of performing deep reinforcement learning of the transmit power control device 10 is shown. Before deep reinforcement learning is performed, a fraction-specific frequency band may be allocated to VUEs VUE1, VUE2, and VUE3 included in a sub-system, and hyperparameters, such as a learning rate, the number of epochs, weight initialization, and the like, may be set to implement an optimal training model.

When deep reinforcement learning starts, roles of the VUEs VUE1, VUE2, and VUE3 may be set in accordance with positions thereof in the sub-system (S100). The transmit power control device 10 may set a foremost VUE in a travel direction of vehicles in a fraction as a first VUE VUE1, set VUEs other than the first VUE in the fraction as second VUEs VUE2, and set a VUE in another fraction and most adjacent to the first VUE VUE1 in the travel direction of the vehicles as a third VUE VUE3.

The first to third VUEs VUE1, VUE2, and VUE3 may perform data communication with another VUE or a base station BA through a first communication link or a second communication link.

The transmit power control device 10 may collect network state information corresponding to a state of an MDP (S110). Here, the network state information may be defined on the basis of information that may be measured in a VUE which receives data. The third VUE VUE3 which receives data from the first VUE VUE1 through an upward first communication link V2V may be set as a first receiving VUE. The base station BA which receives data from the first VUE VUE1 through an upward second communication link V2I may be set as a second receiving VUE. The VUEs VUE1, VUE2, and VUE3 which receive data from the base station BA through downward second communication links V2I may be set as third receiving VUEs. The first VUE VUE1 which receives data from the second VUEs VUE2 through upward first communication links may be set as a fourth receiving VUE. CSI and SE information may be collected from each of the first to fourth receiving ends.

The transmit power control device 10 may determine a capacity of the replay memory 300 that is changed as network state information is collected, and extract a transition batch from the replay memory 300 when the capacity of the replay memory 300 is exceeded (S120).

The transmit power control device 10 may determine transmit power corresponding to each of the roles of the VUEs VUE1, VUE2, and VUE3 through a policy network (S130). Here, the transmit power control device 10 may transmit power allocation information corresponding to actions of the VUEs, and transmit power allocation information may include transmit power of the second VUEs VUE2, transmit power of the first VUE VUE1 for the upward first communication links, transmit power of the first VUE VUE1 for the upward second communication link, and transmit power of the base station BA for the downward second communication links.

Then, the transmit power control device 10 may calculate communication quality information and output a reward value for a VUE (S140).

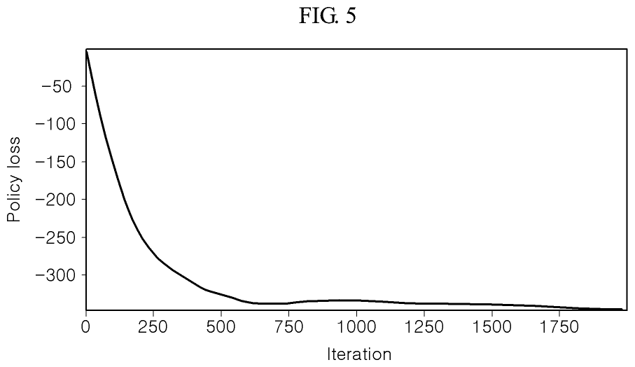

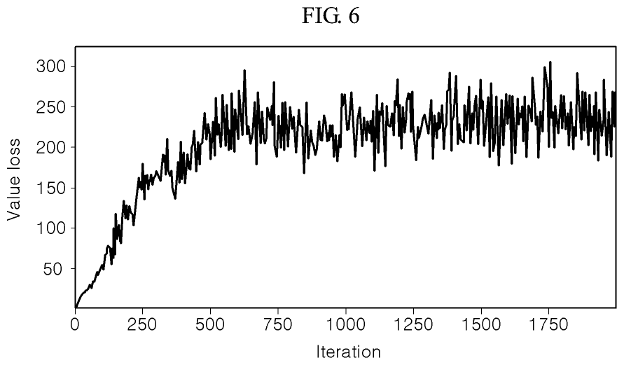

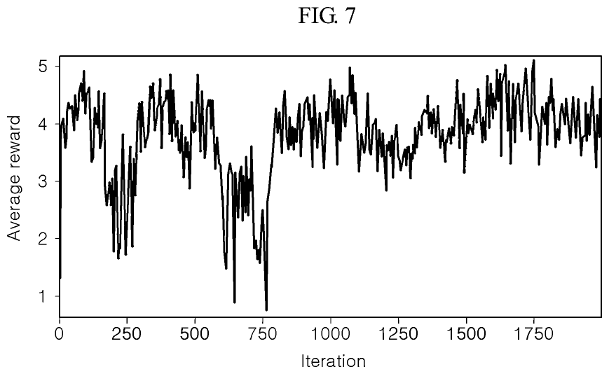

FIG. 5 is a graph showing a loss value of a policy network versus epoch according to an exemplary embodiment of the present invention, FIG. 6 is a graph showing a loss value of a value network versus epoch according to an exemplary embodiment of the present invention, and FIG. 7 is a graph showing a reward value of a policy network versus epoch according to an exemplary embodiment of the present invention.

Referring to FIGS. 5, 6, and 7, learning curves are shown regarding a loss value of a policy network and a loss value of a value network versus epoch. In reinforcement learning, calculating an action or a value during an update of the policy network 110 or the value network 210 may be a factor that significantly destabilizes the learning. Accordingly, in calculating an action or value, network parameters may be fixed, and a network update may be separately performed.

When convergence is not easy and a target network has a very large change, a network update is highly likely to diverge. Accordingly, the DDPG algorithm employs a soft update to gradually update the network, and the policy network 110 and the value network 210 may converge in a certain range as epochs proceed. A reward value is reduced in a specific range of epochs, but is maintained in a certain range when learning is performed for more than 750 epochs.

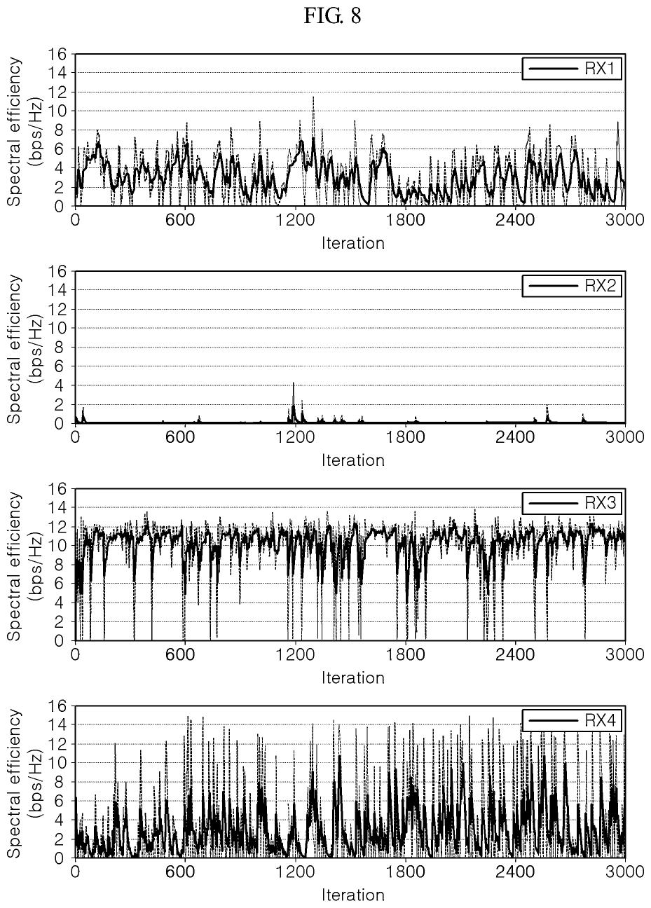

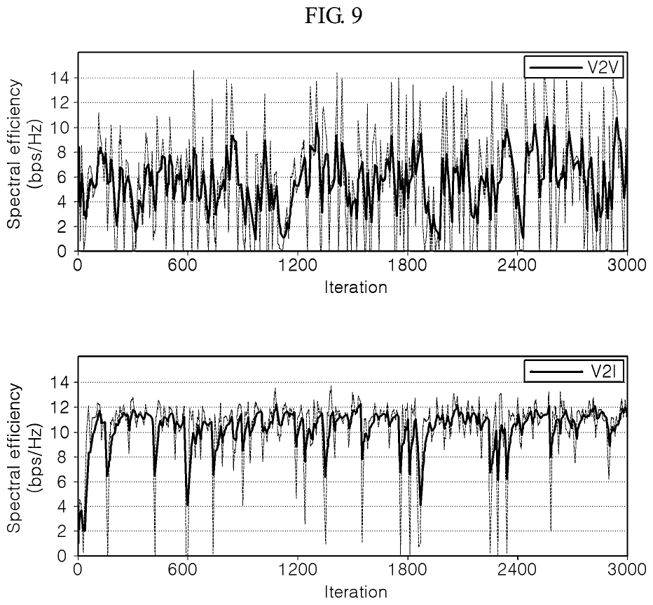

FIG. 8 is a graph showing SE information of first to fourth receiving UEs versus epoch according to an exemplary embodiment of the present invention, and FIG. 9 is a graph showing SE of first and second communication links versus epoch according to an exemplary embodiment of the present invention.

Referring to FIGS. 8 and 9, network state information is information measurable by a VUE which receives data, and may be defined as CSI and SE information in first to fourth receiving UEs RX1, RX2, RX3, and RX4.

The first receiving UE RX1 is the third VUE VUE3 that receives data from the first VUE VUE1 through the upward first communication link V2V, the second receiving UE RX2 is the base station BA that receives data from the first VUE VUE1 through the upward second communication link V2I, the third receiving UEs RX3 are the VUEs VUE1, VUE2, and VUE3 that receive data from the base station BA through the downward second communication link V2I, and the fourth receiving UE RX4 is the first VUE VUE1 that receives data from the second VUEs VUE2 through the upward first communication link V2V. Each of the first to fourth receiving UEs RX1, RX2, RX3, and RX4 maintains a certain range of SE as epochs proceed.

The first communication links V2V established between the VUES VUE1, VUE2, and VUE3 and the second communication links V2I established between the VUES VUE1, VUE2, and VUE3 and the base station BA also maintain a certain range of SE as epochs proceed.

A full-duplex NOMA-based transmit power control device employing deep reinforcement learning according to an exemplary embodiment of the present invention can minimize SI and CCI that are caused when full-duplex NOMA is adopted.

In addition, with a full-duplex NOMA-based transmit power control device employing deep reinforcement learning according to an exemplary embodiment of the present invention, it is possible to provide a transmit power control algorithm device and method optimized for full-duplex NOMA which requires sophisticated control, on the basis of a DDPG algorithm for processing a continuous action space most efficiently.

The above-described exemplary embodiments may be implemented using hardware components, software components, and/or a combination of hardware components and software components. For example, the devices, methods, and components described in the embodiments may be implemented using a general-purpose computer or a special-purpose computer such as a processor, a controller, an arithmetic logic unit (ALU), a digital signal processor, a microcomputer, a field programmable gate array (FPGA), a programmable logic unit (PLU), a microprocessor, or any other device for executing instructions and responding thereto. A processing device may execute an operating system (OS) and a software application running on the OS. Also, the processing device may access, store, manipulate, process, and generate data in response to execution of software. For convenience of understanding, one processing device may be used, but those skilled in the art will understand that the processing device includes a plurality of processing elements and/or a plurality of types of processing elements. For example, the processing device may include a plurality of processors or a processor and one controller. In addition, other processing configurations, such as parallel processors, may be used.

Software may include a computer program, code, instructions, or a combination of one or more thereof and configure a processing device to operate as desired or instruct a processing device to operate independently or collectively. Software and/or data may be permanently or temporarily embodied by any type of machine, component, physical device, virtual equipment, computer storage medium or device, or a signal wave being transmitted to be interpreted by a processing device or provide instructions or data to a processing device. Software may be distributed on computer systems connected via a network and stored or executed in a distributed manner. Software and data may be stored in a computer-readable medium.

A method according to an embodiment may be implemented in the form of program instructions that are executable by various computing devices, and recorded on a computer-readable medium. The computer-readable medium may include program instructions, data files, data structures, and the like alone or in combination. Program instructions recorded on a medium may be specially designed and configured for embodiments or may be known and available to those skilled in computer software. Examples of the computer-readable recording medium may include magnetic media, such as a hard disk, a floppy disk, and magnetic tape, optical media, such as compact disc (CD)-read-only memory (ROM) and a digital video disc (DVD), magneto-optical media, such as a floptical disk, and hardware devices which are specially configured to store and execute program instructions such as a ROM, a random access memory (RAM), a flash memory, and the like. Examples of program instructions include not only machine language code generated by a compiler but also high-level language code that may be executed by a computer using an interpreter or the like.

The hardware device described above may be configured to operate as one or more software modules to perform operations of embodiments, and vice versa.

Although the embodiments have been described above with reference to the limited drawings, those of ordinary skill in the art can apply various technical modifications and variations based on the embodiments. For example, even when the described technique is executed in a different order from the described method, and/or even when components of the system, structure, device, circuit, and the like are coupled or combined in a different form from the described method or replaced or substituted by other components or equivalents, an appropriate result can be achieved.

Therefore, other implementations, other embodiments, and equivalents of the claims fall within the scope of the following claims.

What is claimed is:

1. A full-duplex non-orthogonal multiple access (NOMA)-based transmit power control device employing deep reinforcement learning, the transmit power control device comprising:
a network state information collector configured to set a role of each of vehicle user equipments (VUEs) constituting a sub-system in a hyper-fractionated zone of a Manhattan mobility model and collect network state information from the sub-system;
an actor network configured to determine transmit power of each of the VUEs on the basis of the network state information collected by the network state information collector;
a reward calculator configured to calculate a reward value for the network state information collected by the network state information collector and the transmit power determined by the actor network;
a replay memory configured to store the network state information collected by the network state information collector, the transmit power determined by the actor network, and the reward value calculated by the reward calculator; and
a critic network configured to evaluate the transmit power determined by the actor network and give feedback to the actor network.

2. The transmit power control device of claim 1, wherein the sub-system includes VUEs that are present in the hyper-fractionated zone of the Manhattan mobility model and share the same frequency resources in a cellular network-based vehicle communication system.

3. The transmit power control device of claim 1, wherein, in the sub-system, the same frequency resources are shared,
first communication links are established between the VUEs,
second communication links are established between the VUEs and a base station,
each of the VUEs transmits data using the first and second communication links as uplink, and
the base station receives data using the second communication links as downlink.

4. The transmit power control device of claim 3, wherein the network state information collector sets a foremost vehicle user equipment (VUE) in a travel direction of vehicles in a fraction among the VUEs as a first VUE, sets the VUEs other than the first VUE in the fraction as second VUEs, and sets a VUE in another fraction and most adjacent to the first VUE in the travel direction of the vehicles as a third VUE.

5. The transmit power control device of claim 4, wherein the first VUE transmits a superimposed signal to upward first communication links between the first VUE and the second VUEs and an upward second communication link between the first VUE and the base station using a transmit power difference, and
the base station transmits a superimposed signal to downward second communication links between the base station and the VUEs using the transmit power difference.

6. The transmit power control device of claim 1, wherein the network state information collector comprises:
a channel state information (CSI) calculator configured to collect CSI measurable by a receiving end among the VUEs included in the sub-system;
a spectral efficiency (SE) information measurer configured to collect SE information measurable by the receiving end among the VUEs included in the sub-system;
a user-base station distance measurer configured to measure a distance between a VUE present at a center of the VUEs included in the sub-system and the base station; and
a user-user distance estimator configured to estimate distances between the VUEs included in the sub-system.

7. The transmit power control device of claim 6, wherein the CSI calculator collects signal-to-interference-plus-noise ratios (SINRs) measured by the receiving end among the VUEs included in the sub-system and measures degrees of signal attenuation related to self-interference (SI) and co-channel interference (CCI) caused by full-duplex communication and CCI caused by NOMA.

8. The transmit power control device of claim 6, wherein the SE information measurer measures SE measured by the receiving end among the VUEs included in the sub-system and determines whether communication quality of a cellular network-based vehicle communication system has improved.

9. The transmit power control device of claim 6, wherein the user-base station distance measurer measures distances between the VUEs and the base station and generates information required for deriving transmit power to collect decoding of a superimposed signal and estimates distances between the VUEs to derive transmit power for minimizing co-channel interference (CCI).

10. The transmit power control device of claim 1, wherein the reward calculator calculates communication quality information on the basis of the network state information and the transmit power and outputs the communication quality information as a reward.

11. The transmit power control device of claim 1, wherein the actor network comprises:
a policy network configured to determine the transmit power;
a target-policy network for stable learning; and
an actor optimizer configured to optimize the policy network.

12. The transmit power control device of claim 11, wherein the policy network determines optimal transmit power using the reward calculated from the network state information and transmit power for a previous state,
the target-policy network separately determines transmit power to prevent an unstable result from being caused by an update of the policy network during a process in which the policy network determines the transmit power, and performs a soft update of mixing parameters of the policy network and parameters of the target-policy network at certain intervals to update the target-policy network, and
the actor optimizer includes an algorithm for maximizing a reward to update the policy network.

13. The transmit power control device of claim 1, wherein, to prevent biased learning, the replay memory stores transition information including state information and a reward of a previous network and state information of a subsequent network, and provides the transition information in deep reinforcement learning.

14. The transmit power control device of claim 1, wherein the critic network includes:
a value network configured to analyze the transmit power derived by a policy network;
a target-value network for stable learning; and
a critic optimizer configured to optimize the policy network.

15. The transmit power control device of claim 14, wherein the value network evaluates the transmit power on the basis of the transmit power derived by the policy network and the network state information and provides feedback to the policy network,
the target-value network separately evaluates the transmit power to prevent an unstable evaluation from being caused by an update of the value network during a process in which the value network evaluates the transmit power, and performs a soft update of mixing parameters of the value network and parameters of the target-value network at certain intervals to update the target-value network, and
the critic optimizer includes an algorithm for maximizing a reward to update the value network.
